(19) United States
(12) Patent Application Publication
(10) Pub. No.: US 2013/0132885 A1
(43) Pub. Date: May 23, 2013

(54) SYSTEMS AND METHODS FOR USING TOUCH INPUT TO MOVE OBJECTS TO AN EXTERNAL DISPLAY AND INTERACT WITH OBJECTS ON AN EXTERNAL DISPLAY

(71) Applicants: Derek L. Maynard, Yamato-shi (JP); Hidetoshi Mori, Yamato-shi (JP); Masaki Matsubara, Sagamihara-shi (JP)

(72) Inventors: Derek L. Maynard, Yamato-shi (JP); Hidetoshi Mori, Yamato-shi (JP); Masaki Matsubara, Sagamihara-shi (JP)

(73) Assignee: LENOVO (SINGAPORE) PTE. LTD., New Tech Park (SG)

(21) Appl. No.: 13/298,668

(22) Filed: Nov. 17, 2011

(51) Int. Cl. G06F 3/048

(52) U.S. Cl. 715/777

(57) ABSTRACT

Systems and methods are disclosed herein that generally involve allowing movement of windows or other user interface objects back and forth between a touch screen display and a non-touch display using only touch inputs. In one embodiment, a “send” touch gesture performed on a window displayed on the touch screen display causes automatic movement of the window to the non-touch display. A tab corresponding to the moved window is then displayed on the touch screen display. The tab can be used to interact with the window using touch inputs, even though the window has been moved to a non-touch display. For example, a “retrieve” touch gesture can be performed on the tab to move the window back to the touch screen display, or a “select” touch gesture can be performed on the tab to bring the moved window to the front and give the moved window focus.

### FIELD

The present invention relates to systems and methods for using touch input to move objects to an external display and interact with objects on an external display.

### BACKGROUND

Many computer systems include a touch screen display that can detect touch input provided by a user. The touch input can be interpreted by the computer system to facilitate interaction with a graphical user interface. For example, using a computer system equipped with a touch screen display, a user can reposition a window within a desktop area of the computer system by touching the display in the area where the window's title bar is rendered and making a dragging motion to move the window to the desired location.

Touch-enabled computer systems can also be coupled to one or more external displays that are not touch-sensitive, for example to expand the computer system's desktop area or to make the computer system's graphical user interface visible to an audience during a presentation. In one exemplary arrangement, a clamshell-type laptop computer can include a touch screen on which a first portion of a desktop is displayed. The laptop computer can also be coupled to an external LCD monitor with no touch capabilities, on which a second portion of the desktop is displayed. In another exemplary arrangement, a tablet computer with a touch screen can be coupled to a projector to project an image onto a projection screen that is not touch-sensitive. The tablet's touch screen can display a first portion of a desktop, while the projection screen displays a second portion of the desktop.

One disadvantage associated with these arrangements is illustrated in FIG. 1A. As shown, it is difficult or impossible to use touch input to move a window or other object 102 from a touch screen display 104 to a non-touch display 106. As the user drags the window 102 towards the non-touch display 106, the user's finger 108 reaches the edge 110 of the touch screen display 104, at which point motion of the window 102 stops. The user must then switch to using a mouse or other input device to finish moving the window 102 to the non-touch display 106.

Another disadvantage associated with these arrangements is illustrated in FIG. 1B. As shown, once a window or other object 102 is positioned on the non-touch display 106, it is impossible to use touch input to interact with the window 102 (e.g., to give the window focus for keyboard input, to resize the window, or to move the window).

U.S. Patent Application Publication No. 2005/0015731 to Mak et al., the entire contents of which are incorporated herein by reference, discloses a computer system in which a desktop area is spread across multiple displays. In the Mak system, a first desktop portion is displayed using a first display, and a second desktop portion is displayed using a second display. A “jump pane” window is shown in the first desktop portion on the first display, in which a reproduction of the second desktop portion is displayed. In other words, the second desktop portion is not only shown on the second display, but also is mirrored in reduced form to a window on the first display. Using only the first display, a user can operate a stylus to drag objects into the “jump pane,” causing them to appear in the second desktop portion on the second display.

In the Mak system, however, the jump pane occupies a significant portion of the first display, wasting valuable desktop and display area. In addition, the jump pane is generally much smaller than the second display, which can make text or icons shown in the jump pane illegible. Even when text and icons shown in the jump pane are legible, they represent very small touch targets that require a high degree of accuracy to select, move, etc. The jump pane also increases the complexity of the user interface and reduces its intuitiveness, as it is not necessarily clear to the user that moving an object to the jump pane will cause it to move to the second display. Displaying the same content in two different locations also can be confusing or distracting to the user.

In view of these and other shortcomings, a need exists for improved systems and methods for using touch input to move objects to an external display and interact with objects on an external display.

### SUMMARY

In one aspect of at least one embodiment of the invention, a method is provided that includes displaying a first portion of a desktop on a first display device, displaying a second portion of the desktop on a second display device, and moving a first window from the first portion of the desktop to the second portion of the desktop in response to a send touch gesture that originates in the first window. The method can also include, after moving the first window, displaying a first control tab corresponding thereto on the first portion of the desktop at an edge of the first display device.

Related aspects of at least one embodiment of the invention provide a method, e.g., as described above, in which the send touch gesture comprises a flick gesture in the direction of the second display device.

Related aspects of at least one embodiment of the invention provide a method, e.g., as described above, in which the edge of the first display device is an edge that is most proximate to the second display device.

Related aspects of at least one embodiment of the invention provide a method, e.g., as described above, in which the first display device is a touch screen display device and the second display device is not a touch screen display device.

Related aspects of at least one embodiment of the invention provide a method, e.g., as described above, that includes decorating the first window and the first control tab with a corresponding label.

Related aspects of at least one embodiment of the invention provide a method, e.g., as described above, in which the corresponding label comprises at least one of a color, a text label, and an image label.

Related aspects of at least one embodiment of the invention provide a method, e.g., as described above, in which the first control tab is displayed without displaying a reproduction of the second portion of the desktop on the first portion of the desktop.

Related aspects of at least one embodiment of the invention provide a method, e.g., as described above, that includes moving the first window from the second portion of the desktop to the first portion of the desktop in response to a retrieve touch gesture that originates in the first control tab.

Related aspects of at least one embodiment of the invention provide a method, e.g., as described above, in which the retrieve touch gesture comprises a drag gesture.

Related aspects of at least one embodiment of the invention provide a method, e.g., as described above, that includes displaying a representation of the first window and the second display device on the first portion of the desktop in response to a move/resize touch gesture performed on the first control tab. The method can also include receiving a touch gesture performed on the representation, the touch gesture being indicative of a move instruction or a resize instruction, and moving or resizing the first window within the second portion of the desktop in response to the touch gesture performed on the representation. It will be appreciated that a move/resize touch gesture can be any of a variety of gestures, including without limitation a tap gesture, double tap gesture, drag gesture, pinch gesture, spread gesture, or any of a number of custom gestures.

Related aspects of at least one embodiment of the invention provide a method, e.g., as described above, that includes moving a plurality of windows from the first portion of the desktop to the second portion of the desktop in response to a plurality of send gestures, each of the plurality of send gestures originating in a corresponding one of the plurality of windows. The method can also include displaying a plurality of control tabs on the first portion of the desktop at an edge of the first display device, each of the plurality of control tabs corresponding to one of the plurality of windows.

Related aspects of at least one embodiment of the invention provide a method, e.g., as described above, that includes automatically arranging the plurality of windows within the second portion of the desktop after they are moved to the second portion of the desktop.

Related aspects of at least one embodiment of the invention provide a method, e.g., as described above, that includes receiving a select touch gesture performed on one of the plurality of control tabs and, in response to the select touch gesture, bringing a window positioned on the second portion of the desktop that corresponds to the control tab on which the select touch gesture was performed to the front and giving the window focus.

In another aspect of at least one embodiment of the invention, a system is provided that includes one or more microprocessors, the one or more microprocessors being programmed to provide a desktop display module configured to display a first portion of a desktop on a first display device and a second portion of the desktop on a second display device. The one or more microprocessors can also be programmed to provide a touch gesture processing module configured to receive touch gestures in the form of information indicative of touch input performed by a user, and a window control module configured to move a first window from the first portion of the desktop to the second portion of the desktop in response to a send touch gesture that originates in the first window and that is received by the touch gesture processing module. The one or more microprocessors can also be programmed to provide a control tab display module configured to display a first control tab corresponding to the first window on the first portion of the desktop at an edge of the first display device after the first window is moved by the window control module.

Related aspects of at least one embodiment of the invention provide a system, e.g., as described above, in which the one or more processors are programmed to provide an interface decoration module configured to decorate the first window and the first control tab with a corresponding label, the corresponding label comprising at least one of a color, a text label, and an image label.

Related aspects of at least one embodiment of the invention provide a system, e.g., as described above, in which the control tab display module is configured to display the first control tab without displaying a reproduction of the second portion of the desktop on the first portion of the desktop.

Related aspects of at least one embodiment of the invention provide a system, e.g., as described above, in which the window control module is configured to move the first window from the second portion of the desktop to the first portion of the desktop in response to a retrieve touch gesture that originates in the first control tab and that is received by the touch gesture processing module.

Related aspects of at least one embodiment of the invention provide a system, e.g., as described above, in which the one or more microprocessors are programmed to provide a representation display module configured to display a representation of the first window and the second display device on the first portion of the desktop in response to a move/resize touch gesture received by the touch gesture processing module. The window control module can be configured to move or resize the first window within the second portion of the desktop in response to a touch gesture performed on the representation, the touch gesture being indicative of a move instruction or a resize instruction and being received by the touch gesture processing module.

Related aspects of at least one embodiment of the invention provide a system, e.g., as described above, in which the window control module is configured to move a plurality of windows from the first portion of the desktop to the second portion of the desktop in response to a plurality of send gestures received by the touch gesture processing module, each of the plurality of send gestures originating in a corresponding one of the plurality of windows. The control tab display module can be configured to display a plurality of control tabs on the first portion of the desktop at an edge of the first display device, each of the plurality of control tabs corresponding to one of the plurality of windows.

Related aspects of at least one embodiment of the invention provide a system, e.g., as described above, in which the window control module is configured to automatically arrange the plurality of windows within the second portion of the desktop after they are moved to the second portion of the desktop.

Related aspects of at least one embodiment of the invention provide a system, e.g., as described above, in which the window control module is configured, in response to a select touch gesture performed on one of the plurality of control tabs and received by the touch gesture processing module, to bring a window positioned on the second portion of the desktop that corresponds to the control tab on which the select touch gesture was performed to the front and to give the window focus.

In another aspect of at least one embodiment of the invention, a non-transitory computer-readable storage medium having a program stored thereon is provided. The program can be configured to cause a microprocessor to execute a desktop display function that causes a first portion of a desktop to be displayed on a first display device and a second portion of the desktop to be displayed on a second display device. The program can also be configured to cause the microprocessor to execute a touch gesture processing function that receives touch gestures in the form of information indicative of touch input performed by a user, and a window control function that moves a first window from the first portion of the desktop to the second portion of the desktop in response to a send touch gesture that originates in the first window and that is received by the touch gesture processing function. The program can also be configured to cause a microprocessor to execute a control tab display function that displays a first control tab corresponding to the first window on the first portion of the desktop at an edge of the first display device after the first window is moved by the window control function.

The present invention further provides devices, systems, and methods as claimed.

### BRIEF DESCRIPTION OF THE DRAWINGS

The invention will be more fully understood from the following detailed description taken in conjunction with the accompanying drawings, in which:

FIG. 1A is a schematic diagram of a computer system that includes a touch screen display and a non-touch display;

FIG. 1B is a schematic diagram of the computer system of FIG. 1A;

FIG. 2A is a schematic diagram of one exemplary embodiment of a computer system that includes a touch screen display, a non-touch display, and one or more software modules that facilitate manipulation of objects displayed on the non-touch display based on touch input applied to the touch screen display;

FIG. 2B is a schematic block diagram of the computer system of FIG. 2A;

FIG. 3A schematically depicts a send operation performed on a window displayed on a touch screen display;

FIG. 3B schematically depicts a control tab displayed on the touch screen display of FIG. 3A after the window is moved to a non-touch display;

FIG. 4A schematically depicts a retrieve operation performed on a control tab corresponding to a window that has been moved to a non-touch display;

FIG. 4B schematically depicts the window of FIG. 4A after it is moved to a touch screen display;

FIG. 5A schematically depicts a plurality of control tabs displayed on a touch screen display after a plurality of windows corresponding thereto are moved to a non-touch display;

FIG. 5B schematically depicts color and text labels used to convey a correspondence relationship between a plurality of control tabs displayed on a touch screen display and a corresponding plurality of windows displayed on a non-touch display;

FIG. 5C schematically depicts three exemplary automatic arrangements of a plurality of windows that have been moved to a non-touch display;

FIG. 5D schematically depicts a select operation performed on a control tab corresponding to a window that has been moved to a non-touch display;

FIG. 6 schematically depicts a size and position fly-out displayed on a touch screen display to allow a window displayed on a non-touch display to be resized or repositioned; and

FIG. 7 is a flow chart that schematically depicts one exemplary method of operation of a computer system.

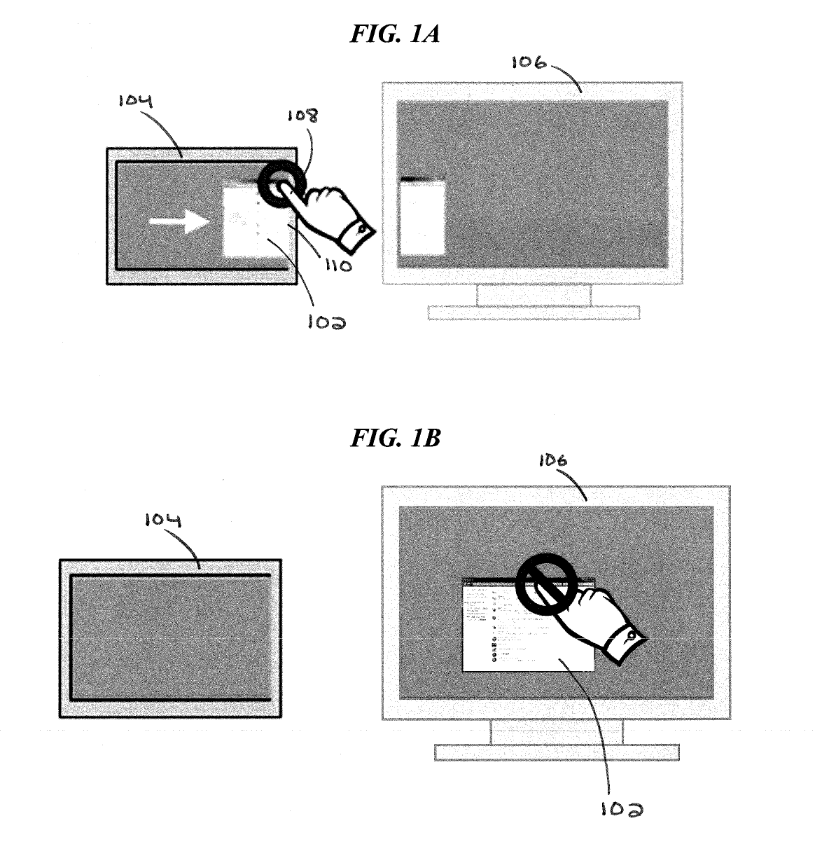

### DETAILED DESCRIPTION

Certain exemplary embodiments will now be described to provide an overall understanding of the principles of the structure, function, manufacture, and use of the methods, systems, and devices disclosed herein. One or more examples of these embodiments are illustrated in the accompanying drawings. Those skilled in the art will understand that the methods, systems, and devices specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention.

Systems and methods are disclosed herein that generally involve allowing movement of windows or other user interface objects back and forth between a touch screen display and a non-touch display using only touch inputs. In one embodiment, a “send” touch gesture performed on a window displayed on the touch screen display causes automatic movement of the window to the non-touch display. A tab corresponding to the moved window is then displayed on the touch screen display. The tab can be used to interact with the window using touch inputs, even though the window has been moved to a non-touch display. For example, a “retrieve” touch gesture can be performed on the tab to move the window back to the touch screen display, or a “select” touch gesture can be performed on the tab to bring the moved window to the front and give the moved window focus. Systems and methods are also disclosed that allow movement and manipulation of windows or other objects displayed on any number external or auxiliary displays using only touch inputs applied to a primary display.

It will be appreciated that the systems and methods disclosed herein can be implemented using one or more computer systems. The term “computer system” as used herein refers to any of a variety of digital data processing devices, including personal computers, desktop computers, laptop computers, tablet computers, server computers, cell phones, PDAs, gaming systems, televisions, radios, portable music players, and the like. The systems and methods disclosed herein can also be implemented in part or in full using software, which can be stored as an executable program or programs on one or more non-transitory computer-readable storage mediums. The term “external display” as used herein can refer to displays that are mounted in a chassis or package that is physically separate from other displays in the system, as well as to displays that are mounted in the same chassis or package as other displays in the system. Thus, in a system that includes multiple displays in a single chassis or package, one or more of the displays can be considered “external,” despite being mounted in the same unit as a primary or other display.

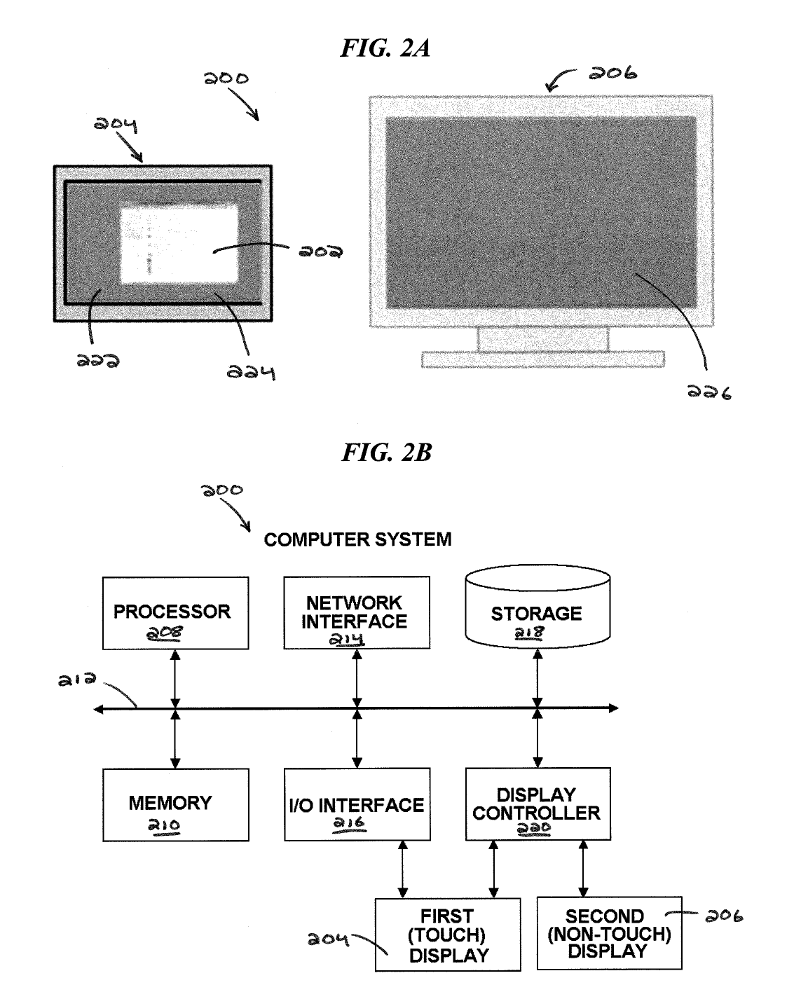

FIGS. 2A-2B illustrate one exemplary embodiment of a computer system 200 in which the systems and methods disclosed herein can be implemented or which can be used in connection with the systems and methods disclosed herein. The computer system 200 can include any of a variety of software and/or hardware components, and it will be appreciated that functions disclosed herein as being performed by a computer system can be implemented in software, hardware, or a combination thereof. In addition, although an exemplary computer system 200 is depicted and described herein, it will be appreciated that this is for sake of generality and convenience. In other embodiments, the computer system may differ in architecture and operation from that shown and described here. Additional information on computer systems can be found in U.S. Patent Publication No. 2009/0150779, the entire contents of which are incorporated herein by reference.

The illustrated computer system 200 includes a processor 208 which controls the operation of the computer system 200, for example by executing an operating system (OS), a basic input/output system (BIOS), device drivers, application programs, and so forth. The processor 208 can include any type of microprocessor or central processing unit (CPU), including programmable general-purpose or special-purpose microprocessors and/or any one of a variety of proprietary or commercially-available single or multi-processor systems. The computer system 200 also includes a memory 210, which provides temporary storage for code to be executed by the processor 208 or for data that is processed by the processor 208. The memory 210 can include read-only memory (ROM), flash memory, one or more varieties of random access memory (RAM), and/or a combination of memory technologies. The various elements of the computer system 200 are coupled to a bus system 212. The illustrated bus system 212 is an abstraction that represents any one or more separate physical busses, communication lines/interfaces, and/or multi-drop or point-to-point connections, connected by appropriate bridges, adapters, and/or controllers.

The computer system 200 also includes a network interface 214, an input/output (IO) interface 216, a storage device 218, and a display controller 220. The network interface 214 enables the computer system 200 to communicate with remote devices (e.g., other computer systems) over a network. The IO interface 216 facilitates communication between one or more input devices (e.g., touch screens, keyboards, or pointing devices), one or more output devices (e.g., speakers, printers, or removable memories), and the various other components of the computer system 200. The storage device 218 can include any conventional medium for storing data in a non-volatile and/or non-transient manner. The storage device 218 can thus hold data and/or instructions in a persistent state (i.e., the value is retained despite interruption of power to the computer system 100). The storage device 218 can include one or more hard disk drives, flash drives, USB drives, optical drives, various media disks or cards, and/or any combination thereof and can be directly connected to the other components of the computer system 200 or remotely connected thereto, such as over a network. The display controller 220 includes a video processor and a video memory, and generates images to be displayed on one or more displays in accordance with instructions received from the processor 208.

The computer system 200 also includes a first display 204 that is capable of receiving touch input from a user (i.e., a touch screen display), for example by detecting the presence and location of a touch event that occurs within a display area 222 of the first display 204. Any of a variety of touch screen display technologies can be used by the first display 204, including capacitive, resistive, optical imaging, infrared, and/or surface acoustic wave (SAW) systems. The first display 204 is coupled to the display controller 220, which provides images to be displayed on the first display 204. The first display 204 is also coupled to the IO interface 216 such that touch inputs performed on or recognized or detected by the first display 204 can be received and processed by the processor 208. Software executed by the processor 208 can recognize or interpret touch inputs as any of a variety of predetermined gestures, such as a tap gesture, a multi-tap gesture, a flick gesture, a drag gesture, a tap and hold gesture, a pinch gesture, a spread gesture, and so forth.

The computer system 200 also includes a second display 206 that is not capable of receiving touch input from a user (i.e., a non-touch display). Exemplary second displays include LCD monitors, CRT monitors, television screens, projection screens, and the like. The second display 206 is also coupled to the display controller 220, which provides images to be displayed on the second display 206. In an exemplary system in which a laptop computer is coupled to an external monitor, the laptop's integrated touch screen display can be considered the first display and the external monitor can be considered the second display.

One or more software modules can be executed by the computer system 200 to facilitate human interaction with the computer system 200. These software modules can be part of a single program or one or more separate programs, and can be implemented in a variety of contexts (e.g., as part of an operating system, a device driver, a standalone application, and/or combinations thereof). It will be appreciated that functions disclosed herein as being performed by a particular module can also be performed by any other module or combination of modules.

In the illustrated embodiment, a desktop display module displays a graphical user interface that includes a desktop area in which various windows and other objects can be displayed. The desktop area can be spread across the touch screen display 204 and the non-touch display 206 such that a first portion 224 of the desktop is displayed on the touch screen display 204 and a second portion 226 of the desktop is displayed on the non-touch display 206. In operation, a user can manipulate objects 202 in the graphical user interface by providing touch inputs to the touch screen display 204. A touch gesture processing module can detect, receive, and/or interpret touch input provided by a user, or information indicative of such touch input. The graphical user interface can then be manipulated in accordance with the touch input, either by the touch gesture processing module or one or more other modules.

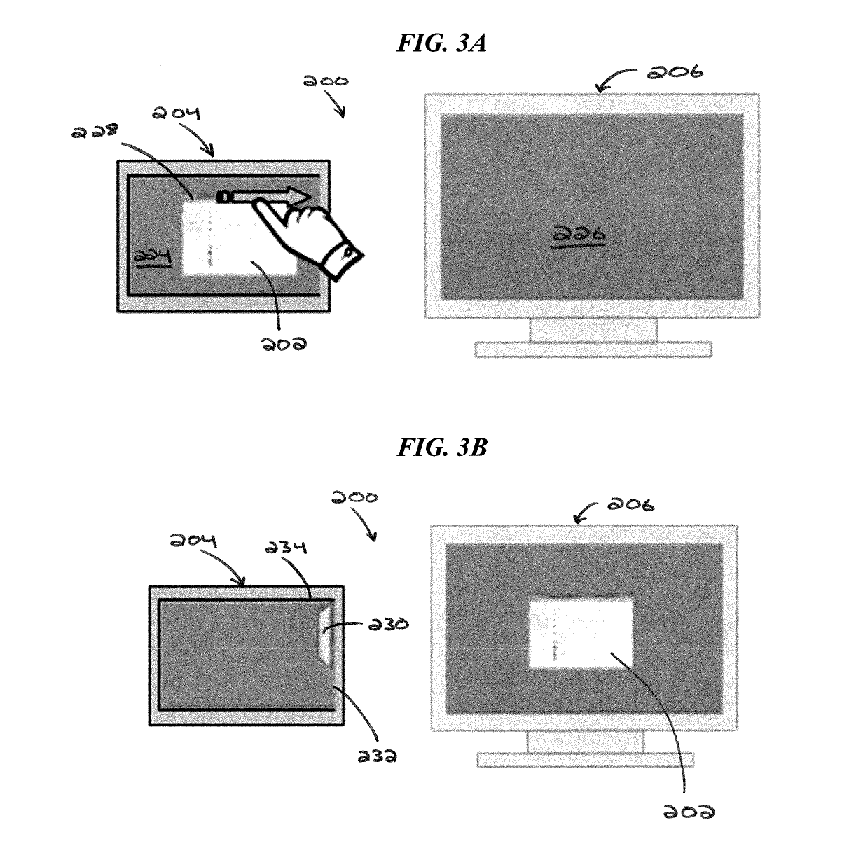

As shown in FIG. 3A, a user can move a window 202 from the first portion 224 of the desktop to the second portion 226 of the desktop (and thus from the touch screen display 204 to the non-touch display 206) by performing a “send” operation. In one embodiment, the send operation includes touching a predetermined portion of the window that the user wishes to move (e.g., the window's title bar 228) and performing a predetermined touch gesture (e.g., a flick gesture in the direction of the non-touch display 206, a drag gesture to the edge of the touch screen display 204, or a drag and hold gesture). It will be appreciated that the touch gesture processing module can have an awareness of the physical location of the non-touch display 206 relative to the touch screen display 204, for example by querying an operating system or display driver, or by receiving physical position information from a user via a settings screen. This awareness allows the touch gesture processing module to determine whether the flick gesture is in the direction of the non-touch display 206, and facilitates operation when a plurality of non-touch displays are provided.

As shown in FIG. 3B, when the touch gesture processing module detects that a send operation has been performed on a window 202, a window control module moves the window 202 to the non-touch display 206 and a control tab display module displays a control tab 230 corresponding to the window 202 on the touch screen display 204. In the illustrated embodiment, the control tab 230 is positioned at the right edge 232 of the touch screen display 204. The edge of the touch screen display 204 at which the control tab 230 is positioned can be selected based on the physical position of the non-touch display 206 to which the window 202 was moved relative to the physical position of the touch screen display 204. Thus, if the window 202 was moved to a non-touch display 206 that is physically positioned above the touch screen display 204, the control tab 230 can be displayed along the upper edge 234 of the touch screen display 204. In the illustrated embodiment, the non-touch display 206 is physically positioned to the right of the touch screen display 204, and therefore the tab 230 can be positioned along the right edge 232 of the touch screen display 204. The illustrated control tab 230 is relatively large, in the sense that it has a size sufficient to be targeted by a human digit without requiring a high degree of accuracy, and thus provides improved usability. At the same time, the illustrated control tab 230 is positioned out of the way, at an edge 232 of the touch screen display 204. Also, since the tab 230 can be displayed without displaying a reproduction of the second portion 226 of the desktop on the first portion 224 of the desktop (e.g., a reproduction of the type disclosed in the Mak reference), wasting of valuable desktop real estate can be avoided.

When a window 202 is moved to the non-touch display 206, its size, position, and/or other properties can be automatically adjusted based on any of a variety of predetermined behaviors, which can optionally be user-configurable. For example, the window 202 can be automatically centered, left-aligned, right-aligned, top-aligned, bottom-aligned, tiled, layered, maximized, minimized, brought to the front, sent to the back, etc. upon being moved to the non-touch display 206. In addition, the movement of the window 202 to the non-touch display 206 can automatically cause the window 202 to be given focus for keyboard or other input, or to automatically lose focus.

The illustrated system 200 thus permits a window 202 to be completely moved onto a non-touch display 206 (or any other type of display) using only touch input.

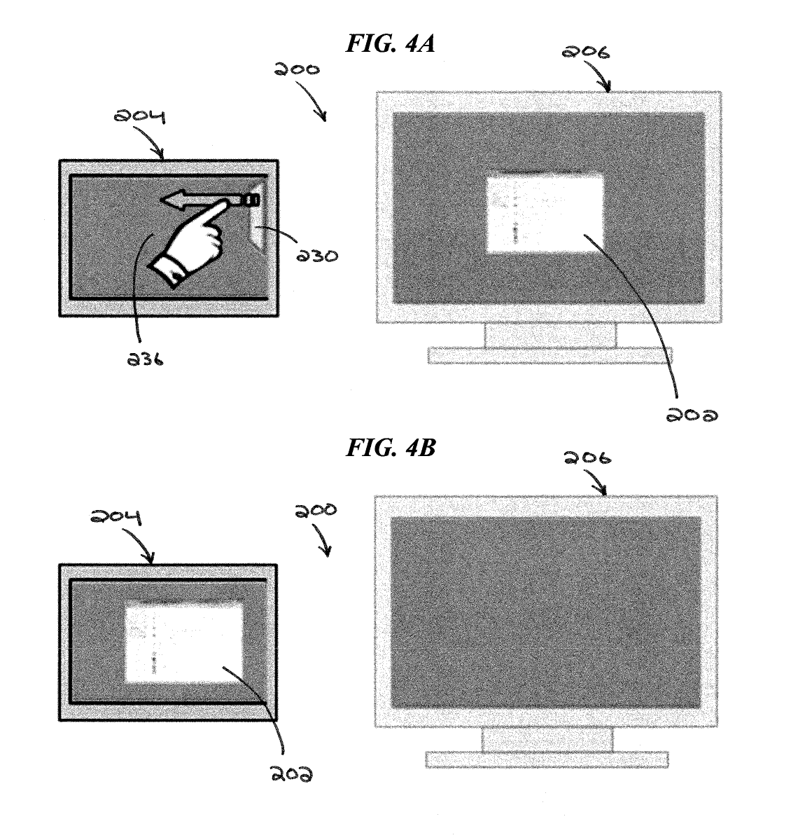

As shown in FIGS. 4A-4B, the control tab 230 shown on the touch screen display 204 after a window 202 is sent to the non-touch display 206 can advantageously permit a “retrieve” operation to be performed to return the window 202 to the touch screen display 204, again using only touch input. In one embodiment, the retrieve operation includes touching the control tab 230 corresponding to the window 202 that the user wishes to move and performing a predetermined touch gesture (e.g., a drag gesture in the direction of the center 236 of the touch screen display 204, or a drag gesture in a direction away from the non-touch display 206).

As shown in FIG. 4B, when the touch gesture processing module detects that a retrieve operation has been performed on a control tab 230 corresponding to a window 202 on the non-touch display 206, the window 202 is moved to the touch screen display 204 and the control tab 230 corresponding to the window 202 is destroyed. When a window 202 is moved to the touch screen display 204, its size, position, and/or other properties can be automatically adjusted based on any of a variety of predetermined behaviors, which can optionally be user-configurable. For example, the window 202 can be automatically centered, left-aligned, right-aligned, top-aligned, bottom-aligned, tiled, layered, maximized, minimized, brought to the front, sent to the back, etc. upon being moved to the touch screen display 204. In addition, the movement of the window 202 to the touch screen display 204 can automatically cause the window 202 to be given focus for keyboard or other input, or to automatically lose focus. In one embodiment, the window 202 can be returned to the same size and position that it had before being moved to the non-touch display 206. In another embodiment, the window 202 can maintain the size and relative position that it had when it was displayed on the non-touch display 206.

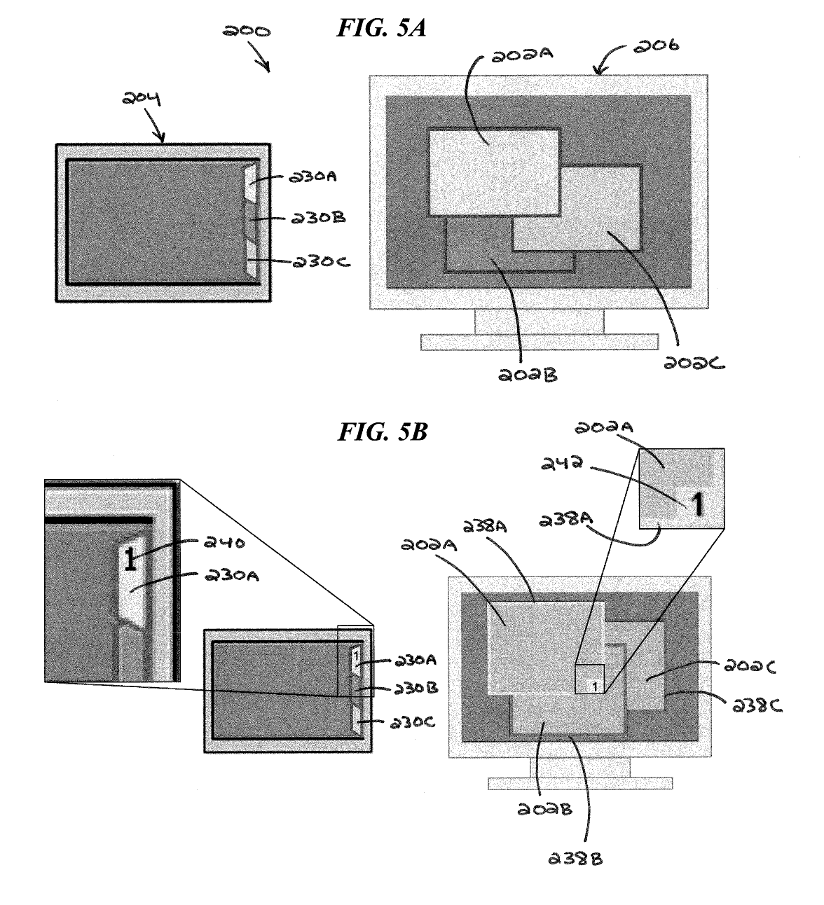

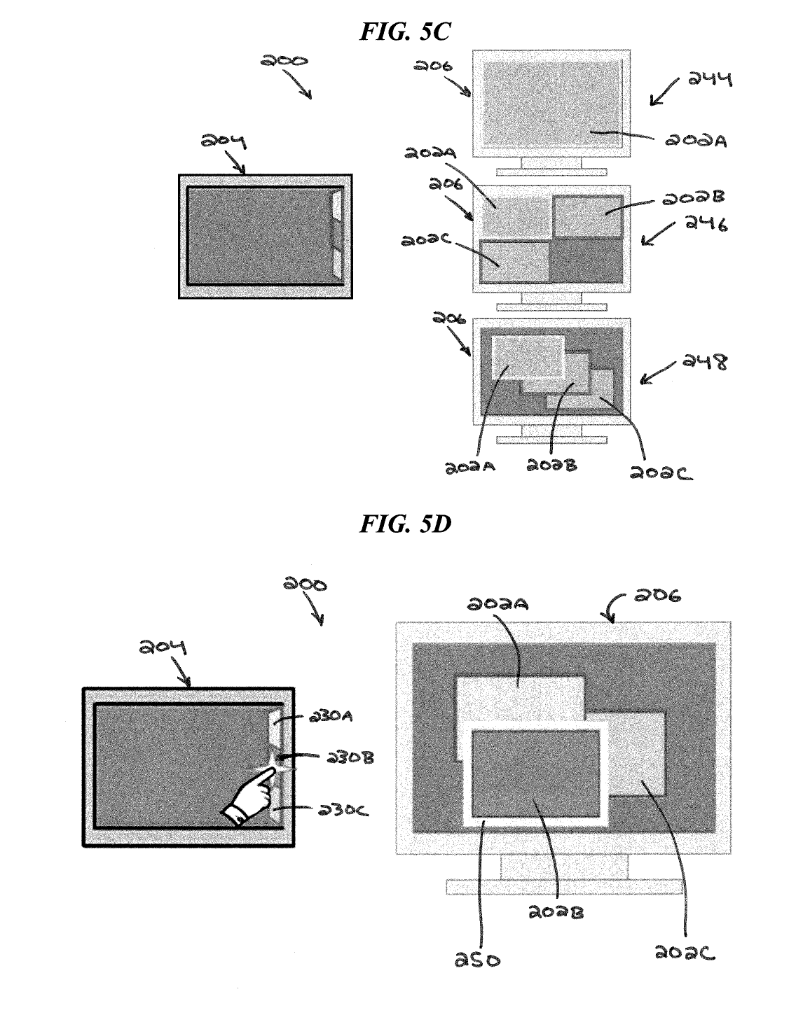

As shown in FIGS. 5A-5D, when additional windows are moved to the non-touch display 206, the control tab display module can be configured to display additional tabs on the touch screen display 204, each tab corresponding to a window that was moved to the non-touch display 206. For example, in the arrangement shown in FIG. 5A, a first window 202A, a second window 202B, and a third window 202C have each been positioned on the non-touch display 206. As a result, a first tab 230A corresponding to the first window 202A, a second tab 230B corresponding to the second window 202B, and a third tab 230C corresponding to the third window 202C are displayed on the touch screen display 204.

In some cases, the window control module may be configured to launch new windows directly to the non-touch display 206, such as when a new application is launched by a user or a new document is opened or created within an application. In these instances, the control tab display module can be configured to automatically draw a tab corresponding to the new window on the touch screen display 204. The control tab display module can thus ensure that all windows shown on non-touch displays have a corresponding tab shown on the touch screen display, such that an ability to interact with such windows using only touch inputs is preserved.

As shown in FIG. 5B, an interface decoration module can provide various window and/or tab decorations to visually illustrate the correspondence relationship between each window and its respective control tab. For example, the windows and tabs can be color coded by providing each window on the non-touch display 206 with a frame having a color that matches a color of the window's corresponding tab. Each of the window/tab pairs can have a unique color, such that the user can readily determine which tab corresponds to which window. Thus, the first tab 230A and a frame 238A surrounding the first window 202A can each be displayed using a first color. Similarly, the second tab 230B and a frame 238B surrounding the second window 202B can each be displayed using a second color that is different from the first color, and the third tab 230C and a frame 238C surrounding the third window 202C can each be displayed using a third color that is different from the first and second colors. While color-coded frames are illustrated in FIG. 5B, any other portion of the window can be color-coded instead or in addition, such as the window's background area, title bar, status bar, toolbar, menu bar, and so on.

In addition to color-coding, or as an alternative thereto, the tabs and windows can be provided with text labels to visually display the correspondence relationships therebetween. In the embodiment illustrated in FIG. 5B, the first tab 230A is provided with a text label 240 consisting of an Arabic numeral, and the window 202A corresponding thereto is provided with a matching numeric label 242. It will be appreciated that any of a variety of labels can be used, such as letters, numbers, text strings, images, icons, or shapes (e.g., square, circle, triangle). In one embodiment, the tabs can be labeled with the name of the application or document embodied by their corresponding window, in which case further labeling of the window itself is not necessarily required. For example, when an instance of a word processing application called

“Word Processor” is displayed in a window on the non-touch display, its corresponding tab can be labeled with “Word Processor.” By way of further example, when a text file named “document1.txt” is displayed in a window on the non-touch display, its corresponding tab can labeled with “document1.txt.”

When multiple windows are moved to the same non-touch display 206, the window control module can be configured to automatically arrange the windows or adjust the size, position, and/or other properties of the windows automatically based on any of a variety of predetermined behaviors. These behaviors can be user-configurable and can be different from the behaviors used when only a single window is moved to the non-touch display 206. As shown in FIG. 5C, a plurality of windows 202A, 202B, 202C moved to the non-touch display 206 can be automatically arranged in a “maximized” configuration 244 in which the window 202A that most recently had focus is maximized. Alternatively, the plurality of windows 202A, 202B, 202C can be automatically arranged in a “tiled configuration” 246 or a “stacked” configuration 248. Any of a variety of other behaviors can also be used.

The touch gesture processing module can also be configured to recognize a “select” operation to permit a user to give focus to a window displayed on a non-touch display 206 or to remove focus from a window displayed on a non-touch display 206 using only touch input. The select operation can also automatically bring a window to the front when focus is applied thereto, or automatically send a window to the back when focus is removed therefrom. In one embodiment, the select operation includes performing a predetermined touch gesture on the control tab corresponding to the window that the user wishes to apply focus to or remove focus from (e.g., a single tap gesture). As shown in FIG. 5D, when a select operation is performed, the window 202B corresponding to the tab 230B on which the select operation was performed is given focus and brought to the front. The window 202B can also be provided with a highlighted or enlarged border 250 to illustrate that it has focus. In other words, in an exemplary embodiment, when the user performs a single tap gesture on the second tab 230B, the second window 202B is brought to the front and given focus. When a select operation is performed on a tab corresponding to a window that already has focus, the module can either do nothing, remove focus from the window, remove focus from the window and send the window to the back, or perform some other function.

The control tabs 230 that are displayed on the touch screen display 204 can optionally be provided with buttons or other controls for manipulating their corresponding windows. For example, each tab can be provided with one or more of a maximize button, a minimize button, a close button, a move button, a resize button, etc. such that these functions can be performed on the corresponding window 202 using only touch input, even through the window 202 is displayed on the non-touch display 206. Instead of providing buttons on the tabs 230 to perform these functions, or in addition thereto, the touch gesture processing module can be configured to associate various touch gestures with these functions. For example, a double tap gesture can be interpreted as a “close window” instruction, or a pinch gesture can be interpreted as a “resize window” instruction.

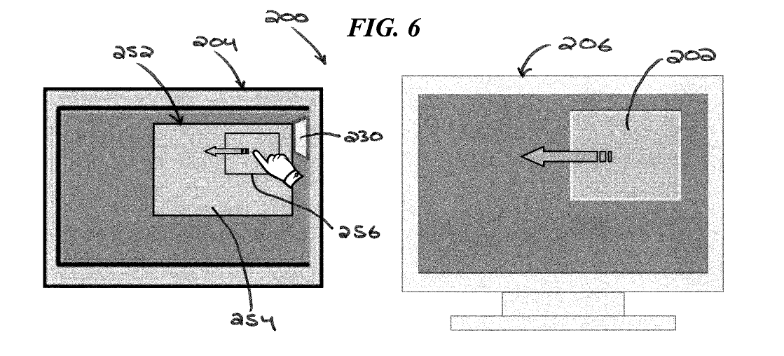

As shown in FIG. 6, a representation display module can be configured to display a size and position fly-out, window, or dialog box 252 when a “move window” or “resize window” instruction is received (e.g., when a move or resize button on one of the tabs 230 is touched, or when a move or resize touch gesture, such as a long tap, is detected with respect to one of the tabs 230). As shown, a size and position fly-out 252 can be positioned adjacent to the control tab 230 to which it corresponds. The fly-out 252 can provide a graphical representation 254 (e.g., a wireframe depiction) of the non-touch display 206 and a graphical representation 256 (e.g., a wireframe depiction) of the window 202 to which the control tab 230 corresponds. The fly-out 252 can also display graphical representations of other windows displayed on the non-touch display 206.

Once the fly-out 252 is displayed, the touch gesture processing module can detect user input within the fly-out, determine whether any of a variety of predetermined size and position adjustment operations have been performed, and instruct the window control module to adjust the size and position of the corresponding window 202 accordingly. For example, a drag gesture that originates within the wireframe representation 256 of the window 202 can be recognized as a move operation. A drag gesture that originates on a top or bottom edge of the wireframe representation 256 can be recognized as an adjust vertical size instruction, and a drag gesture that originates on a right or left edge of the wireframe representation 256 can be recognized as an adjust horizontal size instruction. A drag gesture that originates on a corner of the wireframe representation 256 can be recognized as an adjust vertical and horizontal size instruction. Pinch and spread gestures can be recognized as an enlarge window instruction and a reduce window instruction, respectively. When the user is finished resizing and/or repositioning the window, the fly-out 252 can be dismissed, for example by touching the touch screen display 204 in an area outside of the fly-out 252, by touching a close or cancel button provided on the fly-out 252, or by allowing a predetermined time to elapse without providing touch input to the fly-out 252.

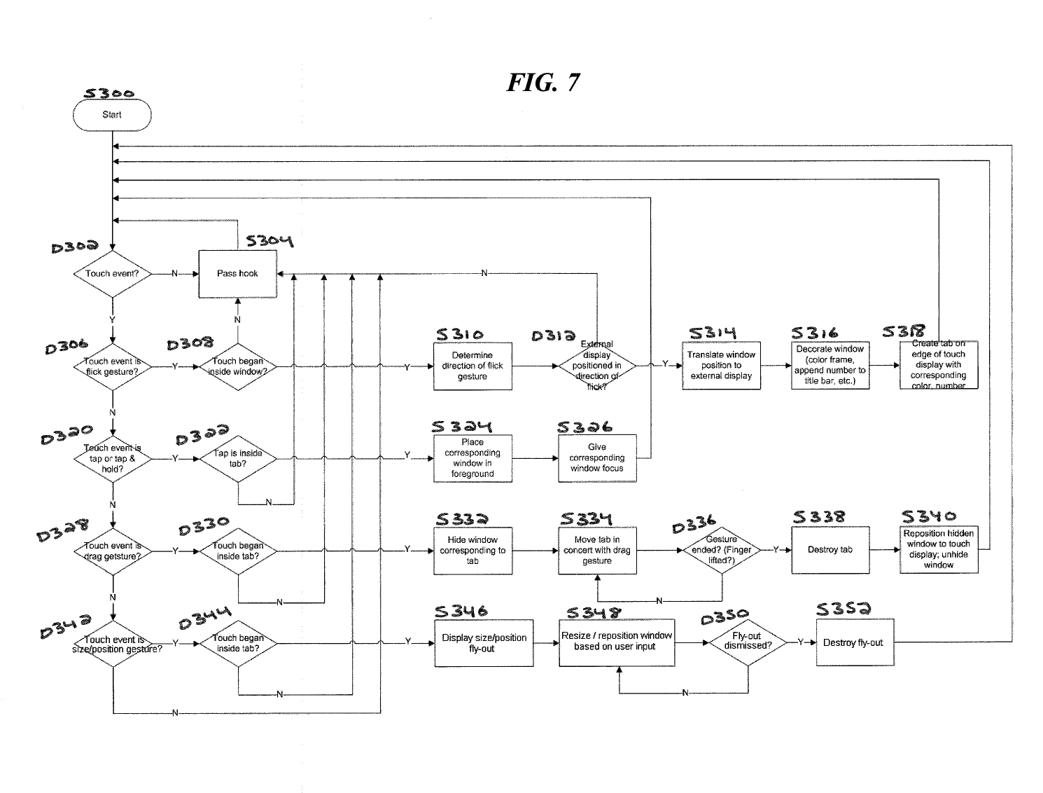

One exemplary method of operation of the computer system 200 is illustrated schematically in the flow chart of FIG. 7. While various methods disclosed herein are shown in relation to a flowchart or flowcharts, it should be noted that any ordering of method steps implied by such flowcharts or the description thereof is not to be construed as limiting the method to performing the steps in that order. Rather, the various steps of each of the methods disclosed herein can be performed in any of a variety of sequences. In addition, as the illustrated flowcharts are merely exemplary embodiments, various other methods that include additional steps or include fewer steps than illustrated are also within the scope of the present invention.

As shown, operation begins at a starting point S300. The system then determines at decision block D302 whether a touch event has occurred. If no touch event has occurred, the system passes a hook to the operating system or other underlying software at step S304 and returns to the starting point S300.

If it is determined at decision block D302 that a touch event has occurred, the system then determines at decision block D306 whether the touch event is a flick gesture. If the touch event is a flick gesture, the system determines at decision block D308 whether the touch began inside a window. If the touch did not begin inside a window, the system passes a hook at step S304 and returns to the starting point S300. If it is determined at decision block D308 that the touch began inside a window, the system determines the direction of the flick gesture at step S310, and then determines whether an external display is positioned in the direction of the flick gesture at decision block D312. If there is no display physically positioned in the direction of the flick gesture, the system passes a hook at step S304 and returns to the starting point S300. If it is determined at decision block D312 that a display is physically positioned in the direction of the flick, the window position is translated to the external display at step S314. The window is then decorated at step S316 (e.g., by adding a color frame or text label), and a tab is created at the edge of the touch screen display with a corresponding decoration at step S318. The system then returns to the starting point S300.

If it is determined at decision block D306 that the touch event is not a flick gesture, the system determines at decision block D320 whether the touch event is a tap gesture or a tap and hold gesture. If the touch event is a tap gesture or a tap and hold gesture, the system determines at step D322 whether the touch event occurred inside a tab. If the touch event did not occur inside a tab, the system passes a hook at step S304 and returns to the starting point S300. If it is determined as decision block D322 that the touch event did occur inside a tab, the window corresponding to the tab is brought to the front at step S324, and the corresponding window is given focus at step S326. The system then returns to the starting point S300.

If it is determined at decision block D320 that the touch event is not a tap gesture or a tap and hold gesture, the system determines at decision block D328 whether the touch event is a drag gesture. If the touch event is a drag gesture, the system determines at decision block D330 whether the drag gesture begin inside a tab. If the drag gesture did not begin inside a tab, the system passes a hook at step S304 and returns to the starting point S300. If it is determined at decision block D330 that the drag gesture did begin inside a tab, the window corresponding to the tab is hidden at step S332. The tab is then moved in concert with the drag gesture at step S334 and it is determined whether the drag gesture has ended at decision block D336. If the drag gesture has not yet ended, the system returns to step S334 and thus continues to move the tab in concert with the drag gesture. This process repeats until the drag gesture ends. When it is determined at decision block D336 that the drag gesture has ended, the tab is destroyed at step S338 and the hidden window is repositioned to the touch screen display and unhidden at step S340. The system then returns to the starting point S300.

If it is determined at decision block D328 that the touch event is not a drag gesture, the system determines at decision block D342 whether the touch event is a size/position gesture. If the touch event is a size/position gesture, the system determines at decision block D344 whether the touch began inside a tab. If the size/position gesture did not begin inside a tab, the system passes a hook at step S304 and returns to the starting point S300. If it is determined at decision block D344 that the touch event began inside a tab, the size/position fly-out is displayed at step S346. The window corresponding to the tab is then resized and/or repositioned based on user input to the fly-out at step S348. The system then determines whether the fly-out has been dismissed at decision block D350. If the fly-out has not been dismissed, the system returns to step S348 and thus continues to resize and/or reposition the window in accordance with user input. This process repeats until the fly-out is dismissed. When it is determined at decision block D350 that the fly-out has been dismissed, the fly-out is destroyed at step S352 and the system returns to the starting point S300.

If it is determined at decision block D342 that the touch event is not a size/position gesture, the system passes a hook at step S304 and returns to the starting point S300.

Although the invention has been described by reference to specific embodiments, it should be understood that numerous changes may be made within the spirit and scope of the inventive concepts described.

For example, while systems and methods are disclosed above in which control tabs 230 are displayed on the touch screen display 204, any of a variety of other graphical objects can be used instead or in addition, such as icons, buttons, and the like. Furthermore, the objects need not necessarily be positioned at an edge of the touch screen display 204.

By way of further example, the systems and methods disclosed herein are not limited to manipulating windows, but rather can be used to manipulate any of a variety of user interface objects, such as text, icons, images, controls, etc.

Also, while systems and methods are disclosed herein that involve one touch screen display 204 and one non-touch display 206, such systems and methods can also include any combination of one or more touch screen displays and one or more non-touch displays, or any combination of two or more touch screen displays and zero or more non-touch displays. Thus, exemplary configurations can include a configuration having one touch screen display and two non-touch displays, a configuration having two touch screen displays and zero non-touch displays, a configuration having three touch screen displays and three non-touch displays, and so forth. In configurations with more than one touch screen display, the control tabs can be displayed on the touch screen display on which the corresponding send operation is performed. In configurations with a primary touch screen display and more than one secondary or external display (whether touch screen displays, non-touch displays, or a combination thereof), windows can be sent to the display that is physically positioned in the direction of a gesture constituting the send operation. In such configurations, the controls tabs can be positioned along an edge of the primary display that is most proximate to the secondary display to which a window has been sent.

As a further example, while systems and methods are disclosed that contemplate touch gestures applied directly to a touch screen display, such systems and methods can also operate using gestures performed using a touch pad, a mouse, a roller ball, a joystick, a keyboard, etc.

Accordingly, it is intended that the invention not be limited to the described embodiments, but that it have the full scope defined by the language of the following claims.

What is claimed is:

1. A method comprising:
displaying a first portion of a desktop on a first display device;
displaying a second portion of the desktop on a second display device;
moving a first window from the first portion of the desktop to the second portion of the desktop in response to a send touch gesture that originates in the first window; and
after moving the first window, displaying a first control tab corresponding thereto on the first portion of the desktop at an edge of the first display device.

2. The method of claim 1, wherein the send touch gesture comprises a flick gesture in the direction of the second display device.

3. The method of claim 1, wherein the edge of the first display device is an edge that is most proximate to the second display device.

4. The method of claim 1, wherein the first display device is a touch screen display device and the second display device is not a touch screen display device.

5. The method of claim 1, further comprising decorating the first window and the first control tab with a corresponding label.

6. The method of claim 5, wherein the corresponding label comprises at least one of a color, a text label, and an image label.

7. The method of claim 1, wherein the first control tab is displayed without displaying a reproduction of the second portion of the desktop on the first portion of the desktop.

8. The method of claim 1, further comprising moving the first window from the second portion of the desktop to the first portion of the desktop in response to a retrieve touch gesture that originates in the first control tab.

9. The method of claim 1, wherein the retrieve touch gesture comprises a drag gesture.

10. The method of claim 1, further comprising:
displaying a representation of the first window and the second display device on the first portion of the desktop in response to a move/resize touch gesture performed on the first control tab;
receiving a touch gesture performed on the representation, the touch gesture being indicative of a move instruction or a resize instruction; and
moving or resizing the first window within the second portion of the desktop in response to the touch gesture performed on the representation.

11. The method of claim 1, further comprising:
moving a plurality of windows from the first portion of the desktop to the second portion of the desktop in response to a plurality of send gestures, each of the plurality of send gestures originating in a corresponding one of the plurality of windows; and
displaying a plurality of control tabs on the first portion of the desktop at an edge of the first display device, each of the plurality of control tabs corresponding to one of the plurality of windows.

12. The method of claim 11, further comprising automatically arranging the plurality of windows within the second portion of the desktop after they are moved to the second portion of the desktop.

13. The method of claim 11, further comprising:
receiving a select touch gesture performed on one of the plurality of control tabs; and
in response to the select touch gesture, bringing a window positioned on the second portion of the desktop that corresponds to the control tab on which the select touch gesture was performed to the front and giving the window focus.

14. A system comprising one or more microprocessors, the one or more microprocessors being programmed to provide:
a desktop display module configured to display a first portion of a desktop on a first display device and a second portion of the desktop on a second display device;
a touch gesture processing module configured to receive touch gestures in the form of information indicative of touch input performed by a user;
a window control module configured to move a first window from the first portion of the desktop to the second portion of the desktop in response to a send touch gesture that originates in the first window and that is received by the touch gesture processing module; and
a control tab display module configured to display a first control tab corresponding to the first window on the first portion of the desktop at an edge of the first display device after the first window is moved by the window control module.

15. The system of claim 14, further comprising an interface decoration module configured to decorate the first window and the first control tab with a corresponding label, the corresponding label comprising at least one of a color, a text label, and an image label.

16. The system of claim 14, wherein the control tab display module is configured to display the first control tab without displaying a reproduction of the second portion of the desktop on the first portion of the desktop.

17. The system of claim 14, wherein the window control module is configured to move the first window from the second portion of the desktop to the first portion of the desktop in response to a retrieve touch gesture that originates in the first control tab and that is received by the touch gesture processing module.

18. The system of claim 14, further comprising:
a representation display module configured to display a representation of the first window and the second display device on the first portion of the desktop in response to a move/resize touch gesture received by the touch gesture processing module;
wherein the window control module is configured to move or resize the first window within the second portion of the desktop in response to a touch gesture performed on the representation, the touch gesture being indicative of a move instruction or a resize instruction and being received by the touch gesture processing module.

19. The system of claim 14, wherein:
the window control module is configured to move a plurality of windows from the first portion of the desktop to the second portion of the desktop in response to a plurality of send gestures received by the touch gesture processing module, each of the plurality of send gestures originating in a corresponding one of the plurality of windows; and
the control tab display module is configured to display a plurality of control tabs on the first portion of the desktop at an edge of the first display device, each of the plurality of control tabs corresponding to one of the plurality of windows.

20. The system of claim 19, wherein the window control module is configured to automatically arrange the plurality of windows within the second portion of the desktop after they are moved to the second portion of the desktop.

21. The system of claim 19, wherein the window control module is configured, in response to a select touch gesture performed on one of the plurality of control tabs and received by the touch gesture processing module, to bring a window positioned on the second portion of the desktop that corresponds to the control tab on which the select touch gesture was performed to the front and to give the window focus.

22. A non-transitory computer-readable storage medium having a program stored thereon, the program being configured to cause a microprocessor to execute:
a desktop display function that causes a first portion of a desktop to be displayed on a first display device and a second portion of the desktop to be displayed on a second display device;
a touch gesture processing function that receives touch gestures in the form of information indicative of touch input performed by a user;
a window control function that moves a first window from the first portion of the desktop to the second portion of the desktop in response to a send touch gesture that originates in the first window and that is received by the touch gesture processing function; and
a control tab display function that displays a first control tab corresponding to the first window on the first portion of the desktop at an edge of the first display device after the first window is moved by the window control function.
